(19) United States
(12) Patent Application Publication
(10) Pub. No.: US 2012/0146859 A1
(43) Pub. Date: Jun. 14, 2012

(54) WIRELESS COMMUNICATION APPARATUS

(75) Inventor: Toshiyuki Hirota, Hino-shi (JP)

(73) Assignee: KABUSHIKI KAISHA TOSHIBA, Tokyo (JP)

(21) Appl. No.: 13/306,906

(22) Filed: Nov. 29, 2011

(30) Foreign Application Priority Data
Dec. 10, 2010 (JP) 2010-275717

(51) Int. Cl. H01Q 1/24

(52) U.S. Cl. 343/702

(57) ABSTRACT

According to one embodiment, an apparatus includes a first antenna corresponding to a frequency band not higher than a predetermined frequency, a second antenna corresponding to a frequency band higher than the predetermined frequency, a first cable includes one end connected to the first antenna, a second cable includes one end connected to the second antenna, a first mixer/distributor connected to another end of the first cable and another end of the second cable, a third cable includes one end connected to the first mixer/distributor, and a wireless communication module connected to another end of the third cable, wherein the first mixer/distributor is configured to mix a first signal received by the first antenna and a second signal received by the second antenna, and to output a mixed signal to the third cable, and the wireless communication module is configured to receive the mixed signal via the third cable.

### CROSS-REFERENCE TO RELATED APPLICATIONS

This application is based upon and claims the benefit of priority from prior Japanese Patent Application No. 2010-275717, filed Dec. 10, 2010, the entire contents of which are incorporated herein by reference.

### FIELD

Embodiments described herein relate generally to a wireless communication apparatus for performing wireless communication using a plurality of frequency bands.

### BACKGROUND

Recently, notebook-type portable personal computers having a function of executing wireless communication with external devices have been developed.

Long Term Evolution (LTE) services have now been introduced to implement a wireless wide area network (WWAN), and the development of personal computers incorporating LTE is advancing. To handle LTE services, an antenna must support new frequency bands such as the 700-, 800-, and 900-MHz bands.

The 700-MHz band is a frequency band lower than conventionally supported bands. That is, the wavelengths of radio signals in the 700-MHz band are long. Also, it is necessary to support newly added LTE frequencies in addition to conventional frequencies. This makes LTE antennas larger than conventional antennas.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of a wireless communication apparatus according to the first embodiment.

FIG. 2 is an exemplary block diagram showing the system configuration of the wireless communication apparatus according to the first embodiment.

FIG. 3 is an exemplary chart showing examples of frequency bands allocated to WWANs in Japan (JP), the United States (US), and Europe (EU).

FIG. 4 is an exemplary flowchart showing a transmitting process of transmitting wireless signals by a wireless communication module in the wireless communication apparatus of the first embodiment.

FIG. 5 is an exemplary flowchart showing a receiving process of receiving wireless signals by antennas in the wireless communication apparatus of the first embodiment.

FIG. 6 is an exemplary perspective view showing a modification of the wireless communication apparatus according to the first embodiment.

FIG. 7 is an exemplary perspective view showing the outer appearance of a wireless communication apparatus according to the second embodiment.

FIG. 8 is an exemplary view showing examples of the frequency bands of communication services supported by the wireless communication apparatus of the second embodiment.

### DETAILED DESCRIPTION

Various embodiments will be described hereinafter with reference to the accompanying drawings.

In general, according to one embodiment, a wireless communication apparatus comprises a first antenna, a second antenna, a first cable, a second cable, a first mixer/distributor, a third cable, and a wireless communication module. The first antenna corresponds to a frequency band not higher than a predetermined frequency. The second antenna corresponds to a frequency band higher than the predetermined frequency. The first cable comprises one end connected to the first antenna. The second cable comprises one end connected to the second antenna. The first mixer/distributor is connected to another end of the first cable and another end of the second cable. The third cable comprising one end connected to the first mixer/distributor. The wireless communication module connected to another end of the third cable. The first mixer/distributor is configured to mix a first received signal received by the first antenna and a second received signal received by the second antenna, and to output a mixed received signal to the third cable. The wireless communication module is configured to receive the mixed received signal via the third cable.

### First Embodiment

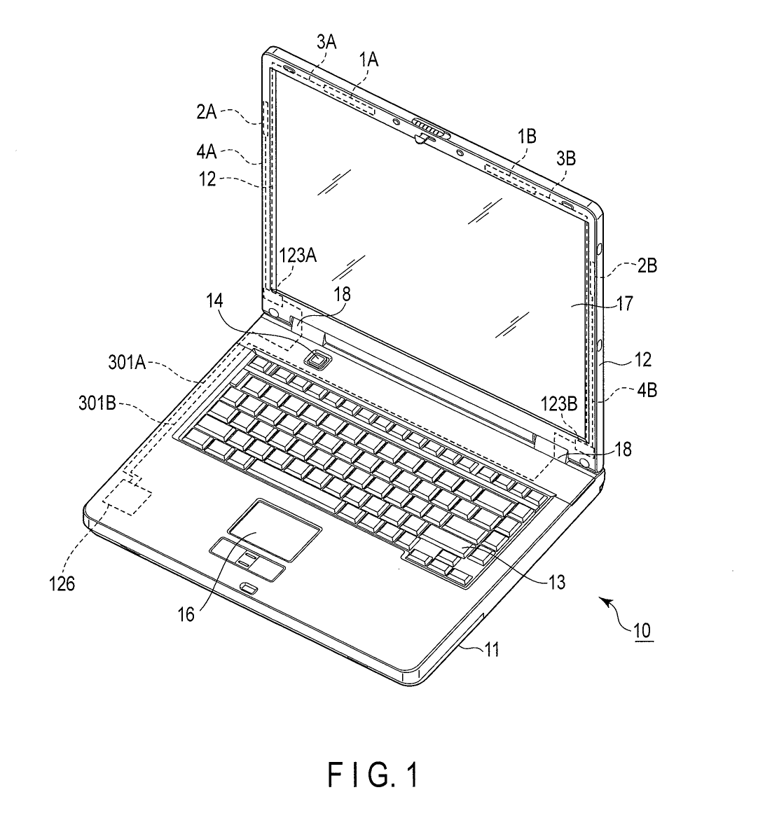

FIG. 1 shows the external appearance of a wireless communication apparatus according to the embodiment. This electronic apparatus is implemented as a battery-powered portable personal computer 10.

FIG. 1 is a perspective view showing a state in which the display unit of the computer 10 is open. The computer 10 includes a computer main body 11 and display unit 12. The display unit 12 incorporates a display device including a liquid crystal display (LCD) 17, and the display screen of the LCD 17 is positioned in almost the center of the display unit 12.

Also, the display unit 12 includes an antenna 1A, antenna 1B, antenna 2A, antenna 2B, mixer/distributor 123A, and mixer/distributor 123B. The antennas 1A (1B) and 2A (2B) correspond to different frequency bands. The antennas 1A and 2A are respectively connected to corresponding ports (antenna terminals) of the mixer/distributor 123A via cables 3A and 4A. The antennas 1B and 2B are respectively connected to corresponding ports (antenna terminals) of the mixer/distributor 123B via cables 3B and 4B. The antennas 1A and 1B are a pair of antennas for transmitting and receiving radio signals by diversity. Likewise, the antennas 2A and 2B are a pair of antennas for transmitting and receiving radio signals by diversity.

The display unit 12 is pivotally attached to the computer main body 11 by hinges 18. The hinges 18 are connecting members for connecting the display unit 12 to the computer main body 11. That is, the display unit 12 is supported by the hinges 18 arranged at the rear end portion of the computer main body 11. The display unit 12 is attached to the computer main body 11 by the hinges 18 so as to be pivotal between an open position in which the upper surface of the computer main body 11 is exposed, and a closed position in which the display unit 12 covers the upper surface of the computer main body 11.

The computer main body 11 is a base unit having a thin box-like housing, and a keyboard 13, a power button 14 for powering on/off the computer 10, a touch pad 16, and the like are arranged on the upper surface of the computer main body 11. Also, the computer main body 11 incorporates a system board (also called a mother-board) including various electronic components, and a wireless communication module 126.

The wireless communication module 126 is a wireless communication device for executing wireless communication with an external device in accordance with, for example, Long Term Evolution (LTE). The wireless communication module 126 corresponds to LTE services in Japan, the United States, and Europe. The wireless communication module 126 is connected to, for example, a bus slot formed on the system board.

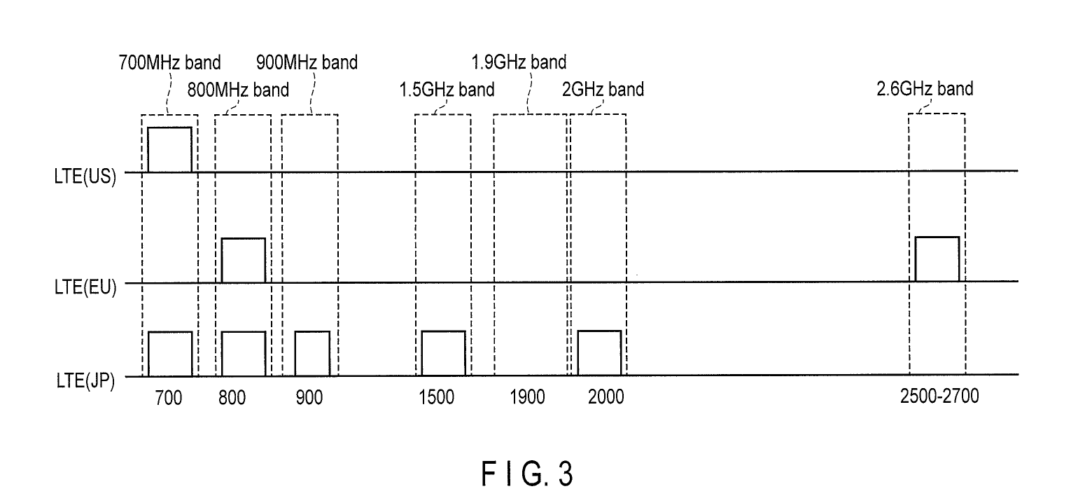

FIG. 3 is a chart showing examples of frequency bands allocated to LTE services in Japan (JP), the United States (US), and Europe (EU). Assume that, as shown in FIG. 3, the 700-MHz, 800-MHz, 900-MHz, 1.5-GHz, and 2-GHz bands are used in Japan, a the 700-MHz band is used in the United States, and the 800-MHz and 2.6-GHz bands are used in Europe.

The wireless communication module 126 receives wireless signals by diversity by means of the antenna 1A (1B) or 2A (2B). The wireless communication module 126 transmits wireless signals by means of one of the antennas 1A (1B) and 2A (2B). The antenna 1A (1B) covers the 700-, 800-, and 900-MHz bands. The antenna 2A (2B) covers the 1.5-, 1.9-, 2-, and 2.6-GHz bands.

The antennas 1A (1B) and 2A (2B) are mounted near, for example, the upper end portion of the display unit 12. Since the antennas 1A (1B) and 2A (2B) are mounted near the upper end portion of the display unit 12, the wireless communication module 126 can execute wireless communication with an external device with the antennas 1A (1B) and 2A (2B) being arranged in relatively high positions.

If a single antenna covers the plurality of frequency bands allocated to LTE, necessary gain may not be obtained in all the frequency bands, and the antenna size may become very large. Therefore, the antenna 1A (1B) covers the 700-, 800-, and 900-MHz bands, and the antenna 2A (2B) covers the 1.5-GHz band and higher.

The upper limit of the 900-MHz band is 960 MHz, and the lower limit of the 1.5-GHz band is 1,427.9 MHz. The mixer/distributor 123A (123B) includes a diplexer, and distributes signals supplied from the wireless communication module 126 to the antennas 1A (1B) and 2A (2B) based on a boundary frequency set between 960 and 1,427.9 MHz. Also, the mixer/distributor 123A (123B) mixes signals received by the antennas 1A (1B) and 2A (2B). Note that the mixer/distributor 123A (123B) can be constructed by one diplexer and three antenna connectors.

The mixer/distributor 123A (123B) in the display unit 12 is connected to the wireless communication module 126 in the computer main body 11 via a cable 301A (301B). The mixer/distributor 123A (123B) in the display unit 12 and the wireless communication module 126 in the computer main body 11 exchange signals via the cable 301A (301B). The cable 301A (301B) is inserted into the internal spaces of the hinges 18. The cable 301A (301B) is, for example, a coaxial cable. The cable 301A (301B) is extended from the computer main body 11 to the display unit 12 via the hinges 18.

In the following explanation, a wireless signal output from the wireless communication module 126 and transmitted outside the personal computer 10 by means of the antenna 1A (1B) or 2A (2B) will be called a transmitted signal, and a wireless signal received from outside the personal computer 10 by means of the antenna 1A (1B) or 2A (2B) and input to the wireless communication module 126 will be called a received signal.

The mixer/distributor 123A (123B) in the display unit 12 mixes received signals input from the antennas 1A (1B) and 2A (2B), and outputs the mixed received signal to the wireless communication module 126 in the computer main body 11 via the cable 301A (301B).

The mixer/distributor 123A (123B) in the display unit 12 distributes transmitted signals input from the wireless communication module 126 in the computer main body 11 via the cable 301A (301B) to the antennas 1A (1B) and 2A (2B) based on the boundary frequency.

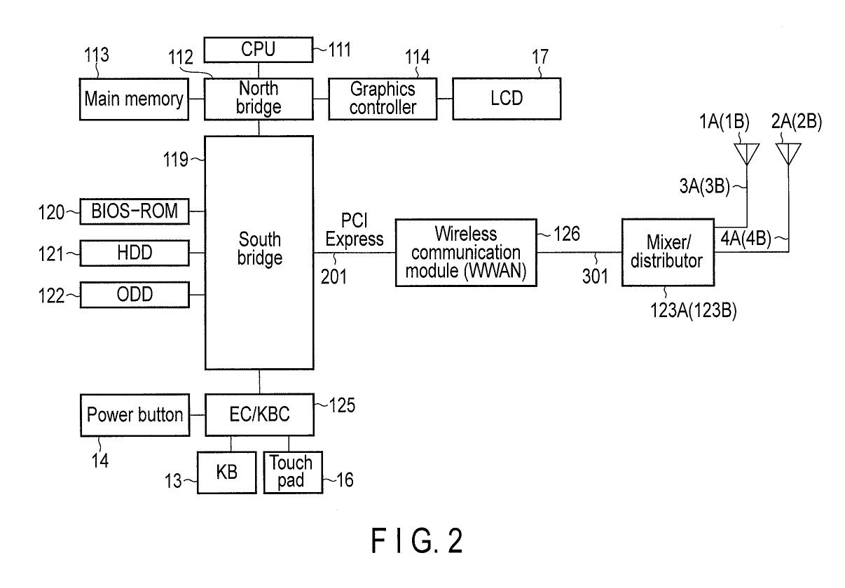

The system configuration of the computer 10 will be explained below with reference to FIG. 2.

The computer 10 includes a CPU 111, a north bridge 112, a main memory 113, a graphics controller 114, a south bridge 119, a BIOS-ROM 120, a hard disk drive (HDD) 121, an optical disk drive (ODD) 122, the mixer/distributor 123A (123B), the wireless communication module 126, an embedded controller/keyboard controller IC (EC/KBC) 125, and the antennas 1A, 1B, 2A, and 2B.

The CPU 111 is a processor for controlling the operation of the computer 10, and executes an operating system (OS) and various application programs loaded from the hard disk drive (HDD) 121 into the main memory 113. The CPU 111 also executes a Basic Input Output System (system BIOS) stored in the BIOS-ROM 120. The system BIOS is a program for controlling hardware.

The north bridge 112 is a bridge device connecting a local bus of the CPU 111 and the south bridge 119. The north bridge 112 also has a function of communicating with the graphics controller 114 via, for example, an Accelerated Graphics Port (AGP) bus.

The graphics controller 114 is a display controller for controlling the LCD 17 used as a display monitor of the computer 10.

The south bridge 119 is a bridge device for controlling various I/O devices. The wireless communication module 126 is connected to the south bridge 119 via a bus 201 such as a Universal Serial Bus (USB).

The wireless communication module 126 is connected to the mixer/distributor 123A (123B) via the cable 301A (301B). The antennas 1A (1B) and 2A (2B) are respectively connected to the mixer/distributor 123A (123B) via the cables 3A (3B) and 4A (4B).

The embedded controller/keyboard controller IC (EC/KBC) 125 is a one-chip microcomputer obtained by integrating an embedded controller for power management, and a keyboard controller for controlling the keyboard (KB) 13 and touch pad 16.

The operation of each component in wireless communication will be explained below. First, an operation of transmitting signals from the wireless communication module 126 will be explained.

The wireless communication module (WWAN module) 126 outputs a transmitted signal based on the LTE standards. The transmitted signal output from the wireless communication module 126 is input to the mixer/distributor 123A (123B) via the cable 301A (301B). From the input transmitted signal, the mixer/distributor 123A (123B) distributes a transmitted signal having a frequency less than or equal to the boundary frequency set between, for example, 960 and 1,427.9 MHz to the antenna 1A (1B), and a transmitted signal having a frequency higher than the boundary frequency set between, for example, 960 and 1,427.9 MHz to the antenna 2A (2B).

Next, an operation of receiving signals by the antennas 1A (1B) and 2A (2B) will be explained.

The antennas 1A (1B) and 2A (2B) receive signals based on the LTE standards. The received signal output from the antenna 1A (1B) is input to the mixer/distributor 123A (123B) via the cable 3A (3B). The received signal output from the antenna 2A (2B) is input to the mixer/distributor 123A (123B) via the cable 4A (4B).

The mixer/distributor 123A (123B) mixes the wireless frequencies (wireless transmission bands) of the input received signals. The mixer/distributor 123A (123B) outputs the mixed received signal to the wireless communication module 126 via the cable 301A (301B).

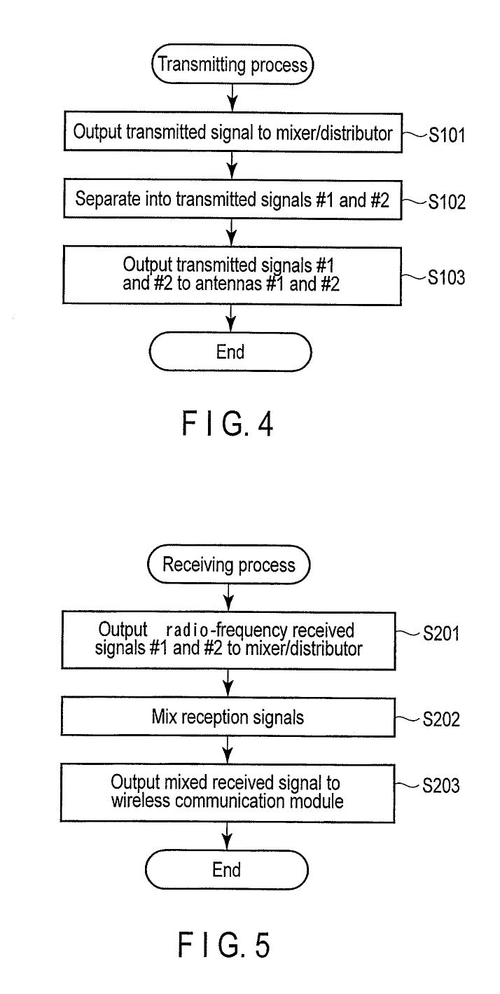

FIG. 4 is a flowchart showing a transmitting process when transmitting wireless signals from the wireless communication module.

First, the wireless communication module 126 outputs a transmitted signal to the mixer/distributor 123A (123B) (block S101).

Then, the mixer/distributor 123A (123B) separates the transmitted signal (block S102). That is, the mixer/distributor 123A (123B) extracts, from the transmitted signal, a transmitted signal #1 having a frequency less than or equal to the boundary frequency, and a transmitted signal #2 having a frequency higher than the boundary frequency. The mixer/distributor 123A (123B) outputs the transmitted signal #1 to the antenna 1A (1B), and the transmitted signal #2 to the antenna 2A (2B) (block S103).

By the above processing, the transmitted signals output from the wireless communication module can be transmitted to the respective corresponding antennas.

FIG. 5 is a flowchart showing a receiving process when receiving wireless signals from the antennas.

First, the antennas 1A (1B) and 2A (2B) respectively output radio-frequency received signals #1 and #2 to the mixer/distributor 123A (123B) (block S201).

Then, the mixer/distributor 123A (123B) mixes the radio-frequency received signals #1 and #2 (block S202). The mixer/distributor 123A (123B) outputs the mixed received signal to the wireless communication module 126 via the cable 301A (301B) (block S206).

By the above processing, signals received by the plurality of antennas can be transmitted to the wireless communication module.

This embodiment can obviate the need for a huge antenna by dividing the frequencies to be supported, and covering the divided frequency bands by a plurality of antennas. If a single antenna covers a plurality of frequency bands, necessary gain may not be obtained. However, necessary gain can be obtained by dividing the frequencies to be supported, and covering the divided frequency bands by a plurality of antennas.

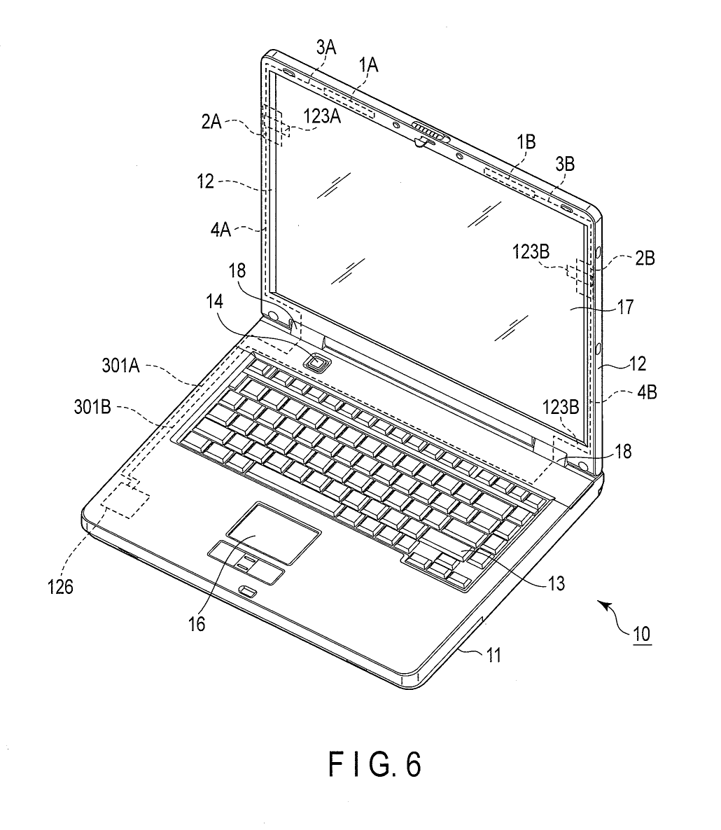

Note that the mixer/distributor 123A (123B) may also be integrated with the antenna 2A (2B), as shown in FIG. 6. Normally, the mixer/distributor 123A (123B) can be constructed by one diplexer and three antenna connectors. These three antenna connectors can be omitted by soldering a cable to the mixer/distributor 123A (123B). That is, the mixer/distributor 123A (123B) can be installed in a very small space. Accordingly, a large cost reduction can be realized by integrating the mixer/distributor 123A (123B) with the antenna without greatly increasing the antenna size, thereby shortening the total cable length, and omitting the mixer/distributor 123A (123B) as a discrete component.

### Second Embodiment

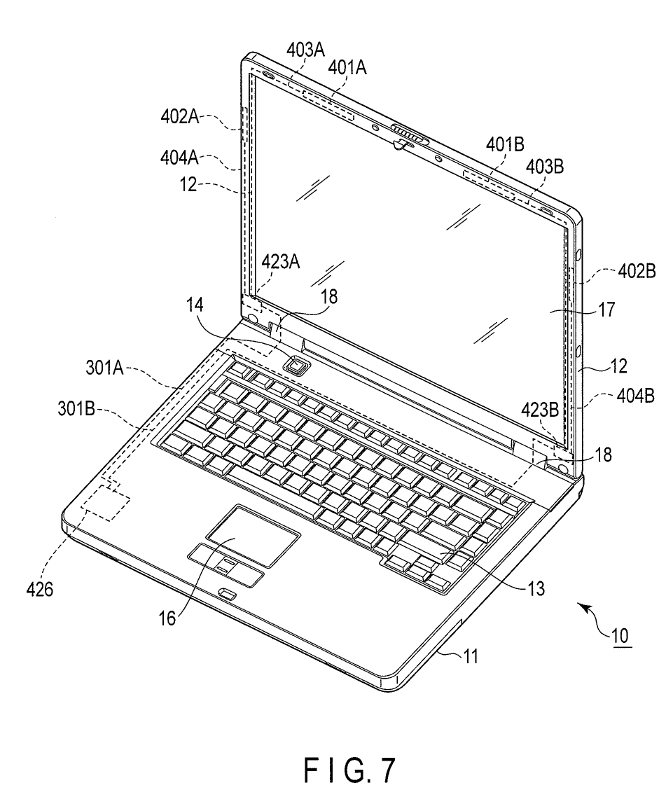

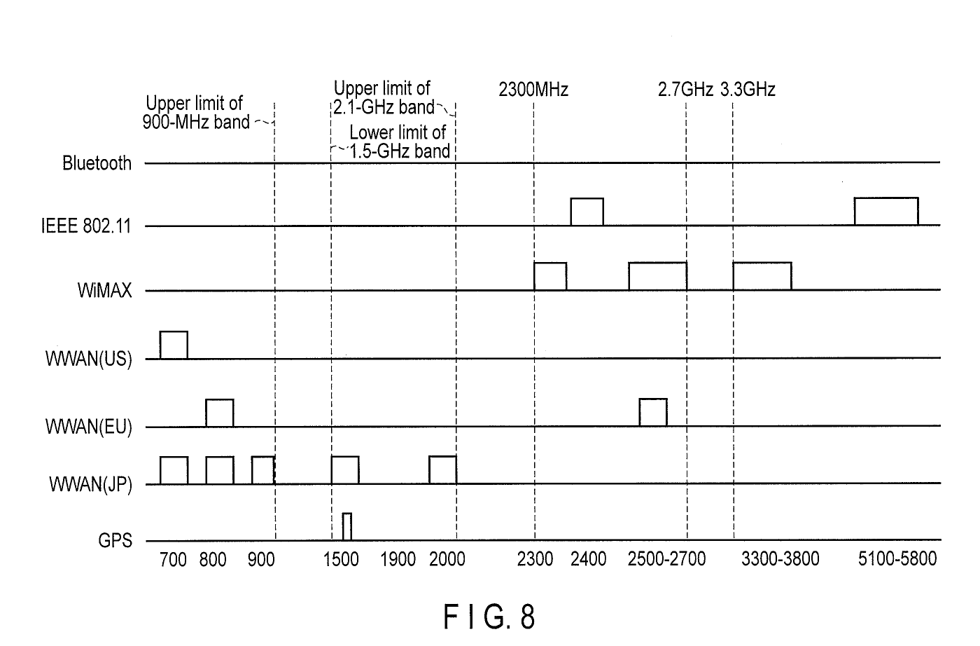

FIG. 7 shows the outer appearance of a wireless communication apparatus according to the embodiment. This electronic apparatus is implemented as a battery-powered portable personal computer 10.

The same reference numerals as in FIG. 1 denote the same parts in FIG. 7, and a repetitive explanation will be omitted.

A display unit 12 includes an antenna 401A, antenna 401B, antenna 402A, antenna 402B, mixer/distributor 423A, and mixer/distributor 423B. The antennas 401A (401B) and 402A (402B) correspond to different frequency bands. The antennas 401A and 402A are respectively connected to corresponding ports (antenna terminals) of the mixer/distributor 423A via cables 403A and 404A. The antennas 401B and 402B are respectively connected to corresponding ports (antenna terminals) of the mixer/distributor 423B via cables 403B and 404B. The antennas 401A and 401B are a pair of antennas for transmitting and receiving radio signals by diversity. The antennas 402A and 402B are a pair of antennas for transmitting and receiving radio signals by diversity.

A wireless communication module 426 executes communication based on a plurality of communication standards. The wireless communication module 426 executes wireless communication with an external device in accordance with, for example, Long Term Evolution (LTE). The wireless communication module 426 executes wireless communication with an external device in accordance with a communication standard such as Bluetooth®. The wireless communication module 426 executes wireless communication with an external device in accordance with a communication standard such as IEEE 802.11. Also, the wireless communication module 426 executes wireless communication with an external device in accordance with a communication standard such as WiMAX.

Bluetooth (BT) uses a frequency band of 2,402 to 2,480 MHz. When the wireless communication module 426 is implemented as a wireless communication module (BT module) for executing wireless communication complying with the Bluetooth standards, the wireless communication module 426 executes wireless communication by means of wireless signals in the frequency band of 2,402 to 2,480 MHz.

A wireless LAN (WLAN) uses frequency bands of, for example, 2,400 to 2,484 MHz, 5,150 to 5,250 MHz, 5,250 to 5,350 MHz, and 5,470 to 5,725 MHz. When the wireless communication module 426 is implemented as a wireless communication module (WLAN module) for executing wireless communication complying with the IEEE 802.11 standards, the wireless communication module 426 executes wireless communication by means of wireless signals in the frequency bands of 2,400 to 2,484 MHz, 5,250 to 5,350 MHz, and 5,470 to 5,725 MHz.

WiMAX uses frequency bands of, for example, 2.3 to 2.4 GHz, 2.5 to 2.7 GHz, and 3.3 to 3.8 GHz. When the wireless communication module 426 is implemented as a wireless communication module (WiMAX module) for executing wireless communication complying with the WiMAX standards, the wireless communication module 426 executes wireless communication by means of wireless signals in the frequency bands of 2.3 to 2.4 GHz, 2.5 to 2.7 GHz, and 3.3 to 3.8 GHz.

The frequency bands used by LTE are explained in the first embodiment, so a repetitive explanation will be omitted. Also, the wireless communication module 426 has a function of receiving signals transmitted from Global Positioning System (GPS) satellites, and calculating the present position based on the received signals.

FIG. 10 is a graph showing examples of frequency bands allocated to Bluetooth, IEEE 802.11, WiMAX, LTE, and GPS.

The frequency band of 2.3 to 2.4 GHz of WiMAX will be described as the 2.3-GHz band hereinafter. The frequency band of Bluetooth and the frequency band of 2,400 to 2,484 MHz of IEEE 802.11 will be described as the 2.4-GHz band hereinafter. The frequency band of 2.5 to 2.7 GHz of WiMAX will be described as the 2.6-GHz band hereinafter. The frequency band of 3.3 to 3.8 GHz of WiMAX will be described as the 3.5-GHz band hereinafter. The frequency band of 5,150 to 5,250 MHz of IEEE 802.11 will be described as the 5.2-GHz band hereinafter. The frequency band of 5,250 to 5,350 MHz of IEEE 802.11 will be described as the 5.3-GHz band hereinafter. The frequency band of 5,470 to 5,725 MHz of IEEE 802.11 will be described as the 5.6-GHz band hereinafter.

The wireless communication module 426 receives wireless signals by diversity by means of the antenna 401A (401B) or 402A (402B). The wireless communication module 426 transmits wireless signals by means of one of the antennas 401A (401B) and 402A (402B). The antenna 401A (401B) covers the 700-, 800-, and 900-MHz bands. The antenna 402A (402B) covers the 1.5-, 1.9-, 2-, 2.3-, 2.4-, 2.6-, 3.5-, 5.2-, 5.3-, and 5.6-GHz bands.

The antennas 401A (401B) and 402A (402B) are mounted near, for example, the upper end portion of the display unit 12. Since the antennas 401A (401B) and 402A (402B) are mounted near the upper end portion of the display unit 12, the wireless communication module 426 can execute wireless communication with an external device with the antennas 401A (401B) and 402A (402B) being arranged in relatively high positions.

If a single antenna covers the plurality of frequency bands from the 700-MHz band to the 5.6-GHz band, necessary gain may not be obtained in all the frequency bands. Therefore, the antenna 401A (401B) covers the 700-, 800-, and 900-MHz bands, and the antenna 402A (402B) covers the 1.5-GHz band and higher.

The upper limit of the 900-MHz band is 960 MHz, and the lower limit of the 1.5-GHz band is 1,427.9 MHz. The mixer/distributor 423A (423B) distributes signals supplied from the wireless communication module 426 to the antennas 401A (401B) and 402A (402B) based on a boundary frequency set between 960 and 1,427.9 MHz.

Note that frequencies less than or equal to 2,170 MHz are allocated to LTE except for Europe. Therefore, the boundary frequency may also be set between 2,170 MHz and 2.3 GHz.

Note also that when supporting a part or the whole of the frequency bands from 700 to 900 MHz of LTE, a single antenna can cover up to 2,700 MHz as the threefold harmonic. Accordingly, the boundary frequency may also be set between 2,700 to 3,300 MHz.

In the following explanation, a wireless signal output from the wireless communication module 426 and transmitted outside the personal computer 10 by means of the antenna 401A (401B) or 402A (402B) will be called a transmitted signal, and a wireless signal received from outside the personal computer 10 by means of the antenna 401A (401B) or 402A (402B) and input to the wireless communication module 426 will be called a received signal.

The mixer/distributor 423A (423B) in the display unit 12 mixes received signals input from the antennas 401A (401B) and 402A (402B), and outputs the mixed received signal to the wireless communication module 426 in a computer main body 11 via a cable 301A (301B).

The mixer/distributor 423A (423B) in the display unit 12 distributes transmitted signals input from the wireless communication module 426 in the computer main body 11 via the cable 301A (301B) to the antennas 401A (401B) and 402A (402B) based on the boundary frequency.

The operation of each component in wireless communication will be explained below.

First, an operation of transmitting signals from the wireless communication module 426 will be explained.

The wireless communication module (WWAN module) 426 outputs a transmitted signal based on the standards of LTE, Bluetooth, IEEE 802.11, and WiMAX. The transmitted signal output from the wireless communication 426 is input to the mixer/distributor 423A (423B) via the cable 301A (301B). From the input transmitted signal, the mixer/distributor 423A (423B) distributes a transmitted signal having a frequency less than or equal to the boundary frequency set between, for example, 960 and 1,427.9 MHz to the antenna 401A (401B), and a transmitted signal having a frequency higher than the boundary frequency set between, for example, 960 and 1,427.9 MHz to the antenna 402A (402B).

Next, an operation of receiving signals by the antennas 401A (401B) and 402A (402B) will be explained.

The antennas 401A (401B) and 402A (402B) receive signals based on the standards of LTE, Bluetooth, IEEE 802.11, WiMAX, and GPS. The received signal output from the antenna 401A (401B) is input to the mixer/distributor 423A (423B) via the cable 403A (403B). The received signal output from the antenna 402A (402B) is input to the mixer/distributor 423A (423B) via the cable 404A (404B).

The mixer/distributor 423A (423B) mixes the wireless frequencies (wireless transmission bands) of the input received signals. The mixer/distributor 423A (423B) outputs the mixed received signal to the wireless communication module 426 via the cable 301A (301B).

This embodiment can obviate the need for a huge antenna by dividing the frequencies to be supported, and covering the divided frequency bands by a plurality of antennas. If a single antenna covers a plurality of frequency bands, necessary gain may not be obtained. However, necessary gain can be obtained by dividing the frequencies to be supported, and covering the divided frequency bands by a plurality of antennas.

Note that the wireless communication module 426 executes wireless communication with external devices in accordance with the communication standards such as Long Term Evolution (LTE), Bluetooth, IEEE 802.11, and WiMAX. However, the wireless communication module 426 need only execute wireless communication with external devices in accordance with the communication standards of at least LTE and WiMAX.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a first antenna corresponding to a frequency band not higher than a first frequency;
a second antenna corresponding to a frequency band higher than the first frequency;
a first cable comprising one end connected to the first antenna;
a second cable comprising one end connected to the second antenna;
a first mixer/distributor connected to another end of the first cable and another end of the second cable;
a third cable comprising one end connected to the first mixer/distributor; and
a wireless communication module connected to another end of the third cable,
wherein the first mixer/distributor is configured to mix a first received signal received by the first antenna and a second received signal received by the second antenna, and to output a mixed received signal to the third cable, and
the wireless communication module is configured to receive the mixed received signal via the third cable.

2. The apparatus of claim 1, wherein
the wireless communication module is configured to output a transmitted signal to the third cable, and
the first mixer/distributor is configured to distribute the transmitted signal input via the third cable into a first transmitted signal comprising a frequency not higher than the predetermined frequency and a second transmitted signal comprising a frequency higher than the predetermined frequency, and to output the first transmitted signal to the first cable and the second transmitted signal to the second cable.

3. The apparatus of claim 2, further comprising:
a third antenna corresponding to a frequency band not higher than the first frequency;
a fourth antenna corresponding to a frequency band higher than the first frequency;
a fourth cable comprising one end connected to the third antenna;
a fifth cable comprising one end connected to the fourth antenna;
a second mixer/distributor connected to another end of the fourth cable and another end of the fifth cable; and
a sixth cable comprising one end connected to the second mixer/distributor, and another end connected to the wireless communication module,
wherein the second mixer/distributor is configured to mix a third received signal received by the third antenna and a fourth received signal received by the fourth antenna, and to output a second mixed received signal to the sixth cable, and
the wireless communication module is configured to receive the mixed received signal via the sixth cable.

4. The apparatus of claim 3, wherein the wireless communication module is configured to receive a wireless signal by diversity using the first antenna and the third antenna.

5. The apparatus of claim 3, wherein the wireless communication module is configured to receive a wireless signal by diversity using the second antenna and the fourth antenna.

6. The apparatus of claim 3, wherein
the wireless communication module is configured to output the transmitted signal to the sixth cable, and
the second mixer/distributor is configured to distribute the transmitted signal input via the sixth cable into a third transmitted signal comprising a frequency not higher than the first frequency and a fourth transmitted signal comprising a frequency higher than the first frequency, and to output the third transmitted signal to the fourth cable and the fourth transmitted signal to the fifth cable.

7. The apparatus of claim 6, wherein the wireless communication module is configured to output the transmitted signal to one of the third cable and the sixth cable.

8. The apparatus of claim 1, further comprising:
a body; and
a display unit pivotally attached to the body via a connecting member,
wherein the wireless communication module is in the body, and
the first antenna and the second antenna are in the display unit.

9. The apparatus of claim 1, wherein the first frequency is a frequency between 960 and 1,427.9 MHz.

10. The apparatus of claim 1, wherein the first mixer/distributor is mounted on one of the first antenna and the second antenna.
